(19) United States
(12) Patent Application Publication
(10) Pub. No.: US 2024/0005306 A1
(43) Pub. Date: Jan. 4, 2024

(54) Multiple Signature Minting and Verification Method and Application

(71) Applicant: Ananj, LLC, Sheridan, WY (US)

(72) Inventor: Nick Mandera, Sheridan, WY (US)

(21) Appl. No.: 18/346,242

(22) Filed: Jul. 2, 2023

Related U.S. Application Data
(60) Provisional application No. 63/357,833, filed on Jul. 1, 2022.

(51) Int. Cl. G06Q 20/36; G06Q 20/38; G06Q 20/40; G06Q 20/10

(52) U.S. Cl. CPC G06Q 20/3672; G06Q 20/389; G06Q 20/401; G06Q 20/3825; G06Q 20/10

(57) ABSTRACT

A multi-signature method for minting and verifying NFTs for use as a login key to access private content. A user buys an NFT that corresponds to particular private content, and that NFT is stored in the user's wallet. When the user wants to access the private content the method parses all the NFTs stored in the user's wallet to find an NFT that corresponds to the private content, and if there is a match, then the user is granted access to that particular private content. The process of minting, buying, and comparing the NFT for use as a login key for access to private content on a website is made possible by a facilitator that earns a fee for every NFT login key created.

### FIELD OF THE INVENTION

The present invention relates to a multiple signature method for minting and verifying non-fungible tokens (NFT's) on a Cardano blockchain. In particular the present invention relates to a multiple signature method for minting and verifying NFT's that allows a user to access private content using the NFT as a login key.

### CROSS-REFERENCE TO RELATED APPLICATIONS

This application claims the benefit of priority to U.S. Provisional Patent Application No. 63/357,833 filed on Jul. 1, 2022, and incorporated in its entirety by reference herein.

### BACKGROUND

Before describing the mechanism for the creation (or minting) and verification of NFTs for use as unique login keys, it is helpful to first briefly review how transactions are executed within the Cardano blockchain. Within each block of data in the blockchain can exist hundreds of individual transactions. Each transaction includes inputs and outputs, of the cryptocurrency Ada and/or of NFTs, each with a unique address identifier, wherein assets are stored on the blockchain ledger in unspent outputs, rather than in accounts, by utilizing the Unspent Transaction Output (UTXO) model. As explained at the public website: https://docs.cardano.org/plutus/eutxo-explainer: “As soon as an output is used as input in a transaction, it becomes spent and can never be used again. In the UTXO model, the output is specified by an address (a public key or public key hash) and a value (consisting of an Ada amount and any optional additional native token amounts). An output's address determines which transactions are allowed to ‘unlock’ the output and use it as an input. A transaction must be signed by the owner of the private key corresponding to the address. Under the UTXO model, an address can be thought of as a ‘lock’ that can only be ‘unlocked’ by the right ‘key’—the correct signature.” Every node on the Cardano blockchain stores a record of all UTXOs at all times, where the record is commonly known as the chain state.

Of interest to the current application, the Cardano blockchain further utilizes an Extended Unspent Transaction Output (EUTXO) model, which is an improvement over the classic UTXO. Again from the website cited above, “the EUTXO model extends the UTXO model in two ways: 1) It generalizes the concept of ‘address’ by using the lock-and-key analogy. Instead of restricting locks to public keys and keys to signatures, addresses in the EUTXO model can contain arbitrary logic in the form of scripts. For example, when a node validates a transaction, the node determines whether or not the transaction is allowed to use a certain output as an input. The transaction will look up the script provided by the output's address and will execute the script if the transaction can use the output as an input. 2) The second difference between UTXO and EUTXO is that outputs can carry (almost) arbitrary data in addition to an address and value. This makes scripts much more powerful by allowing them to carry state information.” User electronic wallets, including for example without limitation, the Cardano blockchain wallets Nami (see https://namiwallet.io/), Eteml (see https://eternl.io/), and Flint (see https://flint-wallet.com/) manage the UTXOs owned by users and allow for the user to initiate transactions on the Cardano blockchain. It should be noted that due to the complexities of blockchain transactions, for example, the use of hash functions, the vast amounts of data that are stored on the blockchain ledger, and the Cardano blockchain mechanism for verification of blockchain transactions, that blockchain transactions are far beyond what can practically be performed in a human mind.

The proliferation of non-fungible tokens (NFTs) as collectible art has produced an enhanced interest in possible other uses for NFTs. A need exists for NFTs that can be used as login keys to access private content, for example, on websites or within applications. It would be useful if the creation and validation for access of such NFTs could be executed transparently to a user and from within a user's electronic wallet. It would be beneficial if a facilitator of the creation and validation of the NFTs could earn a fee for each NFT.

### SUMMARY OF THE INVENTION

In a first aspect of the invention, a method for minting and verifying a blockchain non-fungible token for access to private digital content comprises the steps of purchasing a blockchain non-fungible token (NFT) from an application or website owned by a host, wherein the NFT includes first identifying data that matches second identifying data associated with private digital content stored on the application or website, storing the NFT in an electronic wallet, and accessing the private digital content by verifying that the first identifying data matches the second identifying data.

In another first aspect of the invention, a method for minting and verifying a blockchain non-fungible token for access to private digital content comprises the steps of purchasing a blockchain non-fungible token (NFT) from an application or website owned by a host, wherein the NFT includes first identifying data that matches second identifying data associated with private digital content stored on the application or website, wherein the purchasing step further comprises assembling a blockchain transaction for the creation of the NFT, prompting a user to digitally sign the blockchain transaction, sending the blockchain transaction to a facilitator system back end to further digitally sign the transaction with the first identifying data, and submitting the blockchain transaction to a blockchain for validation. The method further comprises the steps of storing the NFT in an electronic wallet, transferring a first fee for the cost of the NFT from the electronic wallet to the host, and transferring a second fee for facilitation of the transaction from the electronic wallet to the facilitator system. The method further comprises the step of accessing the private digital content by verifying that the first identifying data matches the second identifying data, wherein the accessing step further comprises clicking on a hyperlink associated with the private digital content on the website or within the application, wherein clicking on the hyperlink results in the steps of sending a request for the second identifying data from a front end of a facilitator system to a back end of the facilitator system, storing the second identifying data in the front end of the facilitator system, transferring the first identifying data from the electronic wallet to the front end of the facilitator system, and verifying that the first identifying data matches the second identifying data.

In a further aspect of the invention, a system for minting and verifying a blockchain non-fungible token comprises a blockchain non-fungible token (NFT) having first and second signatures, wherein the first signature is a user's signature, and the second signature is identifying data that is commonly associated with the NFT and private digital content accessible via an application or website.

### BRIEF DESCRIPTION OF THE FIGURES

FIG. 1 is a block diagram illustrating the two main steps of a multi-signature method for minting and verifying NFTs according to an embodiment.

FIG. 2 is a block diagram illustrating the steps of an NFT multiple signature minting method, according to an embodiment; and

FIG. 3 is a block diagram illustrating the steps of an NFT verification method, according to an embodiment.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

In an exemplary embodiment, a multi-signature method 100 for minting and verifying NFTs is practically applied to allow a user to access private or premium content that has been uploaded to websites or within applications owned by a host. In an exemplary practical application of the method, a user buys an NFT having a unique policy ID or other unique identifying data that is designed to correspond to particular private content, and that NFT is stored in the user's wallet. It should be noted that the underlying steps for the minting and verifying the NFTs on the Cardano blockchain involve operations as are more fully explained below that are far beyond what can practically be performed in a human mind.

When the user wants to access the private content, the method compares that unique policy ID or other unique identifying data for all the NFTs stored in the user's wallet to data associated with the private content. Thus, the method for minting and verifying the NFTs is practically applied for use as an enhanced level of security to protect private content from being accessed by those not having paid for the access. For example, if there is a match between the PolicyID of an NFT present in the user's wallet and a PolicyID associated with particular private content on the host's website, then the user is granted access to that particular private content, but if there is no PolicyID match then the user is denied access.

The process of minting, buying, and comparing the NFT for use as a login key for access to private content on the host's website is made possible by a facilitator that earns a fee for every NFT login key created. So, in addition to the enhanced level of security described above, the fee earning ability of the facilitator provides a further practical application of the underlying processes by driving commerce while making the entire process transparent to a user wanting to view private or premium content. The facilitator provides computing hardware and software including devices for storing data on the NFTs and further including a back end and a front end. In an embodiment, the back end is a centralized hardware and software analogous to a server in a server-client architecture. In an embodiment the front end is a distributed part of the system that is analogous to a client in a server-client architecture and includes all software or hardware that is part of a user interface and can be linked to or can communicate with user's wallets.

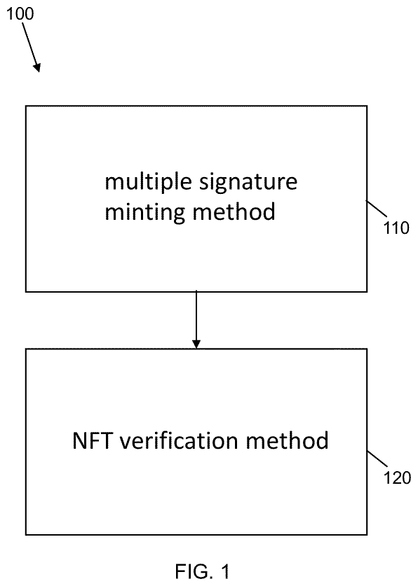

Referring to FIG. 1, in an embodiment the multi-signature method 100 for minting and verifying NFTs has two main parts, which are the multiple signature minting method 110 and the NFT verification method 120. Both parts of the method 100 interface with the front end and the back end and also with that of the host from whose website private content is accessed using the NFT login key. In an embodiment the host website has links to the private content. In another embodiment the host website once accessed provides links to other websites having links to the private content. In an embodiment the host website is presented in a browser that is linked with user electronic wallets installed therein as extensions.

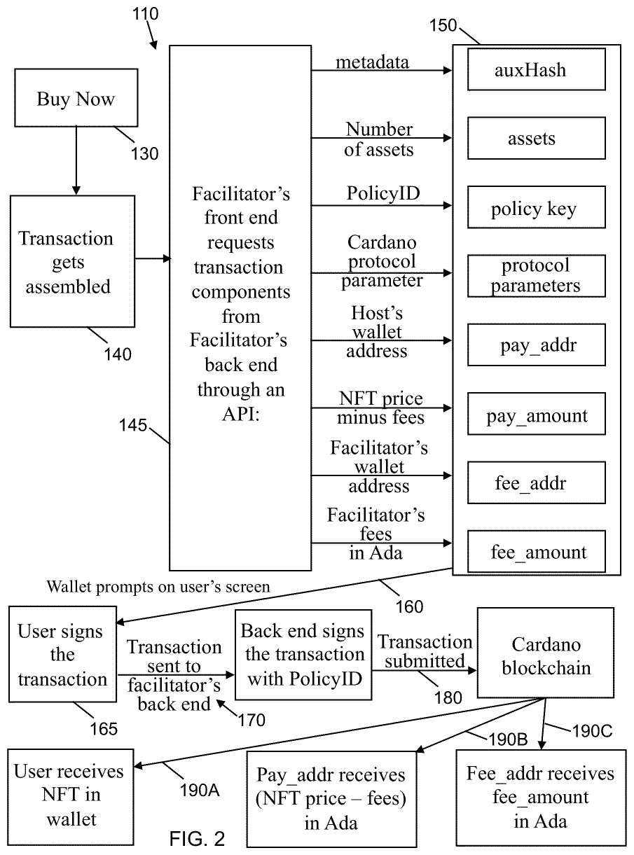

Referring to FIG. 2, in an embodiment the multiple signature minting method 110 starts at step 130 where the user clicks, for example, on a “Buy Now” link or button on a host website to buy an NFT for use as a login key to access private content on the host website. In an embodiment the “Buy Now” link or button is within or operationally linked to the user's electronic wallet which, for example, is installed as an extension on the user's browser. At step 140 a blockchain transaction for creating the NFT gets assembled through step 145 wherein the front end of the facilitator's system requests a number of components from the back end of the facilitator's system. The components making up the transaction body 150 are shown as the multiple sub-blocks in FIG. 2 within the larger rectangular block 150. In an embodiment the front end requests this data from the back end, for example, utilizing a particular application programming interface (API) protocol such as the representational state transfer (REST) protocol (see https://restfulapi.net). In an embodiment step 145, which is far beyond what can practically be performed in a human mind, further utilizes the Cardano serialization library to decode some of the requested parameters (see https://www.npmjs.com/package/@emurgo/cardano-serialization-lib-nodejs).

In an embodiment the first listed sub-block assembled into the transaction body 150 is metadata, which is called in the form of an auxiliary hash of the metadata attached to the NFT, where again the auxiliary hash is the result of an operation that is far beyond what can practically be performed in a human mind. The second sub-block in an embodiment is the number of assets, which identifies the number of assets (NFTs) that can be purchased in a single transaction. The third sub-block in this embodiment is the PolicyID, which is called through the facilitator's back end. The policy key (see https://developers.cardano.org/docs/native-tokens/minting-nfts/#the-policyid) is a unique string for each purchased NFT, and includes an expiration date.

Still referring to FIG. 2, in an embodiment the fourth sub-block includes a predetermined set of Cardano protocol parameters that are necessary to execute the transaction. In an embodiment the facilitator's back end utilizes a third party API, for example without limitation Block Frost (see https://blockfrost.io) to call the set of predetermined parameters from the Cardano blockchain. In an embodiment the retrieved parameters are transferred to the facilitator's front end via a GET request. The Cardano protocol parameters thus retrieved include, for example, variables such as min_fee, min_utxos, pool_deposit, key_deposit, and maxTxsize, all of which are necessary to execute the transaction, and some of which can contain data resulting from the application of operations that could not practically be performed in a human mind. Other embodiments include additional Cardano protocol parameters in addition to those listed above.

The fifth sub-block in an embodiment is the host's unique wallet address, represented by the string pay_addr, which is the blockchain address used to send funds from the user's wallet to the host upon a successful transaction. The sixth sub-block in an embodiment is the price of the NFT minus the facilitator's service fees, represented by the string pay amount, which is the total amount of Ada cryptocurrency that will be transferred to the host's wallet address upon a successful transaction. The seventh sub-block in an embodiment is the facilitator's unique wallet address, represented by the string, fee_addr, which is the blockchain address used to collect a predetermined amount of fees in Ada cryptocurrency upon a successful transaction. The eighth sub-block in an embodiment is the facilitator's fee amount, represented by the string fee_amount, which is the total amount of fees in Ada cryptocurrency that will be transferred to the facilitator's wallet upon a successful transaction.

Still referring to FIG. 2, after the transaction body 150 is assembled via step 145 as described above, in an embodiment at step 160 the facilitator's front end will trigger the signTx function (see https://bit.ly/3usnR0X) of the blockchain wallet (which, for example, is installed as an extension on the user's browser). In an embodiment at step 165 the signTx function will cause a prompt to popup on the user's screen including a link or button that the user clicks to electronically sign the transaction as a witness. In an embodiment at step 170 the transaction is sent to the facilitator's back end, which further signs the transaction with the unique policy key (or keys) for the NFT (or NFTs) (see https://developers.cardano.org/docs/native-tokens/minting/#minting-native-assets). In an embodiment at step 180 the multi-signature transaction is submitted to the Cardano blockchain for validation by the blockchain nodes, which is a process that could not practically be performed in a human mind, resulting in the exchange of ADA and the one or more NFTs in a single transaction.

In an embodiment, at steps 190A-190C the transaction as assembled in the body 150 generates three UTXOs (see https://docs.cardano.org/plutus/eutxo-explainer). At step 190A, the user receives the NFT (or NFTs) in their electronic wallet. At step 190B, the host receives the NFT (or NFTs) price minus the facilitator's fees, and at step 190C the facilitator receives their fees.

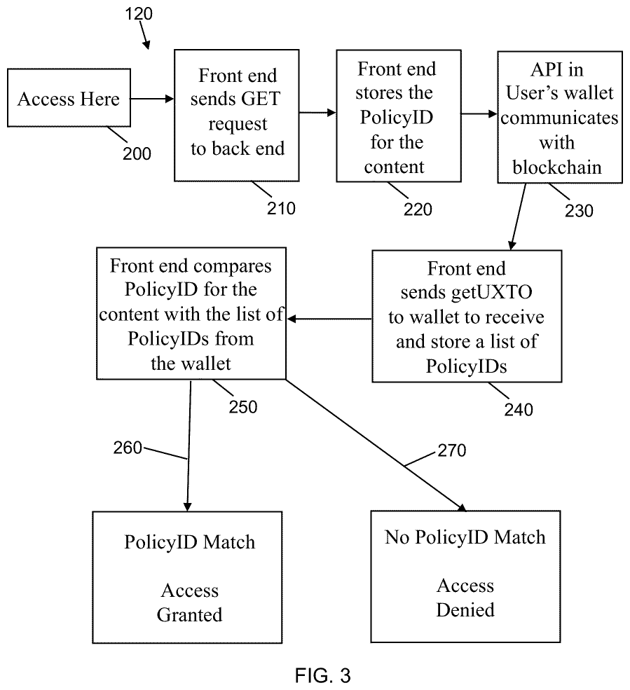

Referring to FIG. 3, in an embodiment, after the user has purchased an NFT login key that is subsequently stored in the user's electronic wallet, the user can access the private content on the host website for which the NFT key was specifically created via the NFT verification method 120. In an embodiment the private content can be accessed, for example, through an associated “Access Here” link or button on the host website, for example, on the same page as the “Buy Here” link or button. In an embodiment of the NFT verification method 120, starting at step 200 when a user clicks on the “Access Here” link or button at step 210 the facilitator's front end sends a GET request to the facilitator's back end requesting the PolicyID associated with the particular content. At step 220 the facilitator's front end stores the PolicyID.

Clicking on the “Access Here” link or button also triggers the User's wallet to communicate to the Cardano blockchain via an API at step 230. At step 240, the facilitator's front end sends a GET request to the User's wallet through “getUXTO” which results in a transfer to the front end of a list of all the UXTOs and all the corresponding PolicyIDs associated with NFTs present in that wallet (see https://bit.ly/3DVKVZ3). At step 240, the facilitator's front end now has the PolicyID of the private content associated with the “Access Here” link or button, and also has a list of all the PolicyIDs associated with purchases made through the User's electronic wallet. At step 250, the front end parses through the list of PolicyIDs from the wallet and compares them to the PolicyID received from the back end.

At step 260, if there is a successful match of the PolicyID, the front end authenticates the User to access the content on the website, for example, via Json Web Token (see https://jwt.io/), and thereby grants access to the particular private content. However, if as shown at step 270 there is not a match, then the front end will prompt a dialog box with a message indicating “Access Denied.”

### INDUSTRIAL APPLICABILITY

A multi-signature method for minting and verifying NFTs allows a user to access private content uploaded to websites or within applications owned by a host. A user buys an NFT having a unique policy ID that is designed to correspond to particular private content, and that NFT is stored in the user's wallet. When the user wants to access the private content the method compares that unique policy ID for all the NFTs stored in the user's wallet to data associated with the private content, and if there is a match with an NFT present in the user's wallet, then the user is granted access to that particular private content. The process of minting, buying, and comparing the NFT for use as a login key for access to private content on the host's website is made possible by a facilitator that earns a fee for every NFT login key created. The method can be used in industry to provide enhanced security for private content while promoting commerce.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

What is claimed is:

1. A method for minting and verifying a blockchain non-fungible token for access to private digital content, the method comprising the steps of:
purchasing a blockchain non-fungible token (NFT) from an application or website owned by a host, wherein the NFT includes first identifying data that matches second identifying data associated with private digital content stored on the application or website;
storing the NFT in an electronic wallet;
accessing the private digital content by verifying that the first identifying data matches the second identifying data.

2. The method of claim 1, wherein the purchasing step further comprises:
assembling a blockchain transaction for the creation of the NFT;
prompting a user to digitally sign the blockchain transaction;
sending the blockchain transaction to a back end of a facilitator system in electronic communication with the application or website to further digitally sign the transaction with the first identifying data; and
submitting the blockchain transaction to a blockchain for validation.

3. The method of claim 2, wherein after the storing step the method further comprises:
transferring a first fee for the cost of the NFT from the electronic wallet to the host; and
transferring a second fee for facilitation of the transaction from the electronic wallet to the facilitator system.

4. The method of claim 2, wherein the assembling step further comprises:
sending a request for components of the blockchain transaction from a front end of the facilitator system to the facilitator system back end, wherein the components comprise the first identifying data, an amount for the first fee, and an amount for the second fee.

5. The method of claim 1, wherein the purchasing step further comprises clicking on a hyperlink associated with the private digital content on the website or within the application, wherein the hyperlink is operationally linked to the electronic wallet.

6. The method of claim 1, wherein the accessing step further comprises clicking on a hyperlink associated with the private digital content on the website or within the application, wherein clicking on the hyperlink results in the steps of:
sending a request for the second identifying data from a front end of a facilitator system in electronic communication with the application or website to a back end of the facilitator system in electronic communication with the application or website;
storing the second identifying data in the front end of the facilitator system;
transferring the first identifying data from the electronic wallet to the front end of the facilitator system; and
verifying that the first identifying data matches the second identifying data.

7. A method for minting and verifying a blockchain non-fungible token for access to private digital content, the method comprising the steps of:
purchasing a blockchain non-fungible token (NFT) from an application or website owned by a host, wherein the NFT includes first identifying data that matches second identifying data associated with private digital content stored on the application or website, and wherein the purchasing step further comprises:
assembling a blockchain transaction for the creation of the NFT;
prompting a user to digitally sign the blockchain transaction;
sending the blockchain transaction to a facilitator system back end to further digitally sign the transaction with the first identifying data; and
submitting the blockchain transaction to a blockchain for validation;
storing the NFT in an electronic wallet;
transferring a first fee for the cost of the NFT from the electronic wallet to the host; and
transferring a second fee for facilitation of the transaction from the electronic wallet to the facilitator system; and
accessing the private digital content by verifying that the first identifying data matches the second identifying data, wherein the accessing step further comprises clicking on a hyperlink associated with the private digital content on the website or within the application, wherein clicking on the hyperlink results in the steps of:
sending a request for the second identifying data from a front end of a facilitator system to a back end of the facilitator system;
storing the second identifying data in the front end of the facilitator system;
transferring the first identifying data from the electronic wallet to the front end of the facilitator system; and
verifying that the first identifying data matches the second identifying data.

8. A system for minting and verifying a blockchain non-fungible token, the system comprising:
a blockchain non-fungible token (NFT) having first and second signatures, wherein the first signature is a user's signature, and the second signature is identifying data that is commonly associated with the NFT and private digital content accessible via an application or website.

9. The system of claim 8, wherein the application or website is owned by a host and is accessible to the user upon electronic presentation of the NFT to the application or the website.

10. The system of claim 9, wherein the NFT is electronically stored in an electronic wallet, and the electronic wallet is installed within the application or as an extension of a browser displaying the website.

11. The system of claim 8, further comprising a facilitator system,
wherein the application or website is owned by a host;
wherein the facilitator system assembles a blockchain transaction for purchase of the NFT by the user, transfers a first fee from an electronic wallet of the user to the host, transfers a second fee from the electronic wallet of the user to itself, and compares the identifying data of the NFT with the identifying data of the private digital content to see if there is a match.
